(19) United States
(12) Patent Application Publication
(10) Pub. No.: US 2025/0134274 A1
(43) Pub. Date: May 1, 2025

(54) UPHOLSTERY

(71) Applicant: Carpenter Engineered Foams Belgium B.V., Machelen (BE)

(72) Inventor: Matthias WILLOCKX, Schendelbeke (BE)

(21) Appl. No.: 18/554,094

(22) PCT Filed: Mar. 25, 2022
(86) PCT No.: PCT/EP2022/057959

§ 371 Date: May 10, 2024

(30) Foreign Application Priority Data
Apr. 6, 2021 (DE) 20 2021 101 798.8

(51) Int. Cl. A47C 27/15; A47C 23/00; A47C 27/06; A47C 27/14

(52) U.S. Cl. CPC A47C 27/15; A47C 23/002; A47C 27/065; A47C 27/144; A47C 27/148

(57) ABSTRACT

An upholstered article is described, especially construed as a mattress 1.1, with a lower layer 2.1 and an upper layer 3.1 and intermediate elements 4.1, 4.2 arranged between the lower layer 2.1 and the upper layer 3, 3.1, wherein the intermediate elements 4.1, 4.2 each comprise a profile axis 6 extending transversely to the longitudinal direction of the upholstered article, wherein, in a cross section 7.1 perpendicular to the profile axis 6, a first intermediate element 4.1, 4.2 provides a first outer contour 8.1 along its periphery, and a second intermediate element 4.2 comprises the same outer contour along its periphery as the first intermediate element 4.1 or a second outer contour 9.1, wherein the first outer contour 8.1 comprises a first contour portion 10.1 with a nonlinear course facing towards the upper layer 3.1 or towards the lower layer 2.1 and wherein, in the first outer contour 8.1 and/or the second outer contour 9.1, at least one counter-contour region 11.1 is present, of which the course is complementary at least in one part to that of the first contour portion 10.1.

The invention relates to an upholstered article, especially a mattress, with a lower layer, an upper layer and intermediate elements arranged between the lower layer and the upper layer, wherein the intermediate elements each comprise a profile axis extending transversely to the longitudinal direction of the upholstered article, wherein, in a cross-section perpendicular to the profile axis, a first intermediate element comprises a first outer contour along its periphery, and a second intermediate element comprises the same outer contour along its periphery as the first intermediate element or a second outer contour.

Mattresses as upholstered articles with two-dimensional upper and lower layers and intermediate elements extending between the latter in the transverse direction of the mattress are already known. For example, DE 27 01 798 A1 describes an intermediate layer for a foam mattress, of which the core comprises loosely inserted foam elements with a circular cross-section placed adjacent to one another in rows. These intermediate elements allow an improved air exchange through the air channels present between the intermediate elements and the adjacent upper and lower layers.

EP 1 031 302 B1 discloses a mattress with a multi-part core made from an elastic material. This comprises trapezoidal inserts in the intermediate layer, which are each rotated through 180° around their profile axis and inserted with an extension in the transverse direction of the mattress. As an alternative in this prior art, profiles with an x-shaped cross-section are described for the intermediate elements.

Through the use of different, replaceable intermediate elements, a mattress can be arranged in the longitudinal direction into zones of different firmness or respectively with different deflection or damping behaviour to match the requirements for each user. To prevent a slipping of such loosely arranged intermediate elements, DE 20 2009 006 062 U1 suggests providing the lower layer of the mattress with transverse grooves open at the top and of which the cross-sectional profile is embodied in such a manner that a lateral support of the intermediate elements is realised. A further possibility for positional fixing of intermediate elements is named in DE 20 2006 002 883 U1. Form-fit elements on the lower mattress layer and on the intermediate elements, extending in the transverse direction are disclosed.

DE 20 2009 008 359 U1 discloses an intermediate mattress layer with intermediate elements of rectangular outline firmly connected to the lower layer of the mattress which comprise recesses of different volume for the adaptation of their resilience (firmness). Further foam elements with different compressive strength can be inserted between these fixed elements.

A mattress with intermediate elements arranged at a distance from one another with different shaping and, if required, also variable density for zoning the latter and accordingly for local adaptation of the resilience, is described in DE 20 2008 001 757 U1. By preference, the contact surfaces of the intermediate elements facing towards the lower and the upper mattress layers are provided with small-scale V-shaped incisions, which are supposed to contribute significantly to ventilation, but, subordinately, also to the realisation of a certain progressive deflection behaviour. In the case of a deflection, the material of the intermediate elements can expand into the V-shaped incisions. These intermediate elements are disposed with their flat, linear upper contour portion in contact with the surface of the upper layer facing towards the respective intermediate element. The profiles known for this function are embodied in such a manner that a separate profile-adaptation cut is necessary when manufacturing the intermediate elements from a block product. Accordingly, the cutting out of the profile of the intermediate elements facing towards the cover layers of the mattress leads to an increased volume of waste material during production.

Additionally, it has been proposed that the lateral faces of the intermediate elements not contacting the cover layers of the mattress are provided with wavy or angled grooves, wherein during the cutting out from a block product, this profiling contacts an adjacent intermediate element in a complementary manner. Intermediate elements which provide a complementary profile on the lateral faces and consequently allow a jigsaw-like arrangement in rows in the cutting pattern of the block product, are described in DE 20 2009 003 512 U1.

Here also, separate profiling steps are necessary for the regions of the profile of the intermediate elements facing towards the lower and upper layers, in which additional waste arises during the cutting of these intermediate elements from a block product.

Starting from the prior art discussed above, the invention is based on the object of providing a multi-layered upholstered article, especially construed as a mattress, which not only provides a high degree of deflection comfort, and this can be different in different zones along the length of the same, but also that the intermediate elements used to build up the upholstered article can be cut in a largely waste-free manner from a block product, so that the latter can be manufactured in a resource-saving and simplified manner.

This object is achieved by a generic upholstered article named in the introduction, especially construed as a mattress, in which the first outer contour comprises a first contour portion with a nonlinear course facing towards the upper layer or towards the lower layer and in that at least one counter-contour region is present in the first outer contour and/or the second outer contour, the course of which is complementary at least in one part to that of the first contour portion.

Advantageous embodiments are evident from the dependent claims and the description.

With the upholstered article according to the invention, in order to determine a first outer contour, a cross-section perpendicular to the profile axis is viewed in a first intermediate element. The outer contour corresponds to the peripheral contour of the cross-section. Incisions or cut-outs introduced into this outer contour, which form a narrow access into an internal cavity in the transverse direction of the respective intermediate element, are possible, but are not considered in the first outer contour designated as the outline contour. The first outer contour defined as the outline geometry therefore bridges any such small-scale incisions or cut-outs. Such incisions can arise when cutting out such an intermediate element from a block product through additional cuts or a blade guiding with a cross-over cutting-line guidance. The second outer contour is defined with correspondingly smoothed contour based on a cross-section selected to agree perpendicularly with the profile axis on the second intermediate element.

The first intermediate element with its first outer contour comprises a first contour portion facing towards the upper layer or towards the lower layer. In a cross-sectional view of the intermediate element, the latter has a nonlinear course or respectively a nonlinear contour. For the specification of the first contour portion with its nonlinear course, its position is important, wherein the former extends in a region of the outer contour which faces towards the upper layer or towards the lower layer of the upholstered article. The extension of the first contour portion in the transverse direction of the intermediate element (in the x-direction) is limited by the extension of the projection of the outer contour in the direction towards the two-dimensional normal to the respectively adjacent upper or respectively lower layer. The nonlinear course is determined by an alternating series of positive structures and negative structures. These structures can be provided by straight or curved cuts or by cuts implemented in a curved shape. Such a nonlinear course of the first contour portion comprises at least one positive structure which merges in each case in the transverse direction of the intermediate element into a negative structure. Such a nonlinear course can be embodied, for example, by two positive structures at the edges and one negative structure disposed between them. Of course, several positive structures and several negative structures can also be provided. Positive and/or negative structures of a smaller scale regarding their span can be superimposed on these structures. Preferred embodiments comprise a convex or concave contour. Symmetrical and asymmetric wavy structures also present possible embodiments for guiding the line of the first contour portion. A large number of other cross-sectional forms is possible for the embodiment of the nonlinear course of the first contour portion.

The nonlinear course of the first contour portion, which contacts the upper or lower layer of the upholstered article, guarantees a progressive deflection behaviour with the special advantage that the comfort of such an upholstered article, for example, embodied as a mattress, is present during the initial deflection in the same manner for a lighter-weight person as for a relatively heavier person. The initial deflection characteristic feels the same for both. Through the nonlinear course of the first contour portion, as a part of the outer contour, the cross-sectional area (area in the x-y plane) participating in a deflection process of the intermediate element is enlarged, because the transitions between positive structures and negative structures relative to a vertical (z-direction) are inclined, and the positive structures are not undercut. With an embodiment of the upper or respectively lower layer with a level flat side (surface) facing towards the intermediate elements, the positive structure or structures contact/s the upper or respectively lower layer, so that, in the case of an unloaded upholstered article, the negative structures remain open and therefore serve as ventilation channels. In the case of a deflection, any air disposed therein is pumped out, and upon subsequent unloading of the upholstered article, fresh air from the environment is drawn in. Accordingly, good internal ventilation is ensured with such an upholstered article.

With such an embodiment, the progressive deflection behaviour described above can also be achieved with an upholstered article in which the intermediate elements are embodied from a material with the same firmness as the upper or respectively lower layer. If the surface of the upper and/or lower layer facing towards the intermediate elements is adapted to the respective contour portion or partially complementary to the latter, the progressive deflection can be achieved if the intermediate elements comprise a different firmness relative to the upper or respectively lower level, wherein the firmness of the intermediate elements is typically greater than that of the upper or respectively lower layer. With such a construction, successively more cross-sectional area of the intermediate elements is also drawn into the deflection process in the case of the first deflection of the intermediate elements.

With a construction of the upholstered article in which the surface of the upper and/or lower layer facing towards the intermediate elements engages in a negative structure, a fixing of the intermediate elements in the longitudinal direction of the mattress (x-direction) is achieved by the form-fit created in this manner. Other means for holding the intermediate elements in place are then not required. In particular, the latter do not need to be glued to the upper or respectively lower layer. Such a multi-layered upholstered article, if embodied, for example, as a mattress, is typically introduced into a mattress cover, by means of which the individual elements are held in their layered arrangement. Such an embodiment allows a replacement of intermediate elements if a different deflection characteristic is to be provided, both through new, different intermediate elements or by switching the position of the intermediate elements of the upholstered article themselves. In this manner, for example, the extension of one zone of the upholstered article can be varied, for example, adapted to the size of a person using such an upholstered article as a mattress.

To keep the cutting waste and therefore the waste material from the intermediate elements cut from a block product, typically a foam block, as small as possible or respectively to avoid completely any such cutting waste, it is specified that at least one counter-contour region is provided on the first outer contour of a further first intermediate element and/or on the second outer contour of a second intermediate element, wherein, at least in one part, and therefore in one portion, the counter-contour region is complementary to that of the first contour portion. This allows an arrangement of the intermediate elements to be cut from a block product in the manner of a jigsaw puzzle, so that for cutting out from a block product, a cutting pattern can be selected with no waste volume or respectively with a significantly reduced waste volume by comparison with conventional processes. Accordingly, congruently shaped first intermediate elements are present in the cutting pattern, arranged in such a manner that the counter-contour region and the first contour portion of adjacent intermediate elements can be separated in a single cut. This dispenses with trimming so that, with the selected shaping, material-saving and therefore resource-saving manufacture is possible without additional processing of regions facing towards the cover layers in the subsequent assembly position.

It is substantial that the complementarity requirement for the first contour portion of the first intermediate element is fulfilled, because the contour course of the first contour portion is decisive for the functionality of the progressive deflection and is therefore embodied accordingly. In a first variant, the complementarity requirement is fulfilled with a counter-contour region as a portion of the first circumferential outer contour of the first intermediate element itself, wherein this counter-contour region can be provided on a lateral face of the first outer contour or on a portion of the first outer contour disposed opposite to the first contour portion.

It is also possible to achieve the desired complementarity through a periodic continuation of the first contour portion, which then forms the counter-contour region. For this advantageous embodiment, the jigsaw-like arrangement of the cutting lines of intermediate elements in the cutting pattern leads, in each case, to an end-face contact of at least two first contour portions of first intermediate elements identical in shape. With such an embodiment, a lateral offset (offset in the x-direction) of the end-face contact can be provided, and indeed in such a manner that, for example, three first intermediate elements form a repeating unit in the cutting pattern.

Furthermore, the counter-contour region can also be embodied in such a manner that the requirement for a shape complementary to the first contour portion is achieved by a reflection or rotation. One possible embodiment is to integrate first intermediate elements which are adjacent in the cutting pattern in such a manner into the upholstered article that they are rotated through 180° relative to their arrangement in the block product.

For a second variant, the complementarity requirement is achieved by adapting the outer contour of a further intermediate element—to the second intermediate element—and accordingly by the second outer contour assigned to the second intermediate element. The second outer contour differs from the first outer contour of the first intermediate element. The counter-contour region within the second outer contour can be provided on a lateral portion or on a portion assigned to the lower layer or the upper layer of the upholstered article.

For the second variant, an embodiment is possible, which comprises a second contour portion on the second outer contour with a nonlinear course facing towards the upper layer or towards the lower layer. Corresponding to the first contour portion of the first intermediate element, the latter serves to influence effectively the firmness (compression strength) within the upholstered article. In particular, the second outer contour should be embodied to achieve a progressive deflection of the second intermediate element. Advantageously, for the jigsaw-like assembly or respectively arrangement relative to one another in the cutting pattern, a further counter-contour region is then also provided on the first outer contour of the first intermediate element, the course of which is complementary, at least in one part, to that of the second contour portion.

For one preferred embodiment, the intermediate elements each provide a constant cross-sectional shape. Embodiments with a cross-section varying in the direction of the profile axis represent an alternative. Furthermore, the axial extension of the intermediate elements is sufficient for an advantageous embodiment over the entire transverse extension of the mattress core. For an improved adaptability, several differently embodied intermediate elements are provided in the transverse direction. Furthermore, in addition to the first and second intermediate element, further intermediate elements with a third or further profile shape can be arranged to create different firmness zones between the upper and the lower layer, wherein, by preference, the further intermediate elements also fulfil the requirement according to the invention for complementarity relative to the first and/or the second intermediate element.

The invention is described in the following paragraphs with reference to the embodiments based on the attached FIGS. The FIGS. show a mattress or detail views of the same as an exemplary upholstered article. The FIGS. are as follows:

FIG. 1: a first exemplary embodiment of a mattress according to the invention in a lateral view,

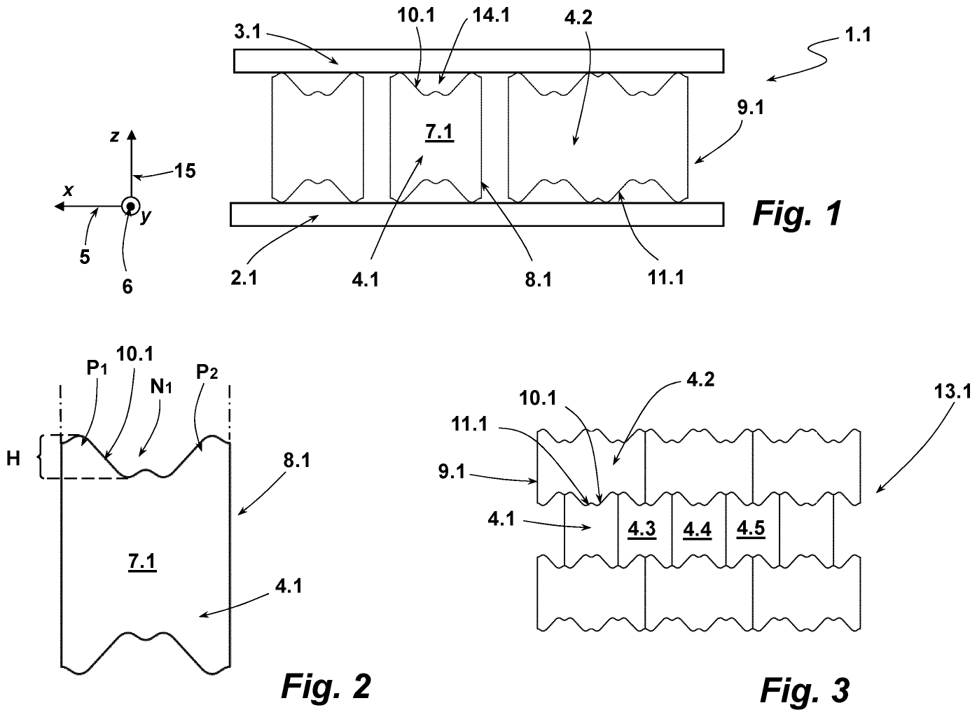

FIG. 2: an enlarged view of the first intermediate element of the mattress from FIG. 1,

FIG. 3: the jigsaw-like arrangement of the intermediate elements of the mattress from FIG. 1 in a cutting pattern,

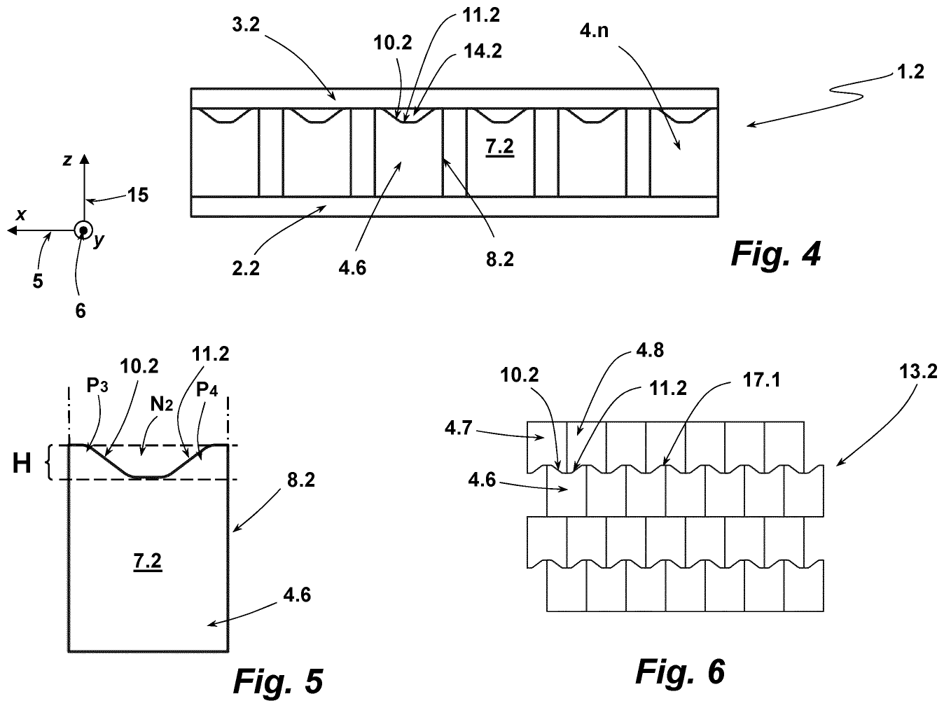

FIG. 4: a second exemplary embodiment of a mattress according to the invention in a lateral view,

FIG. 5: an enlarged view of a first intermediate element of the mattress from FIG. 4,

FIG. 6: the jigsaw-like arrangement of the intermediate elements of the mattress from FIG. 4 in a cutting pattern,

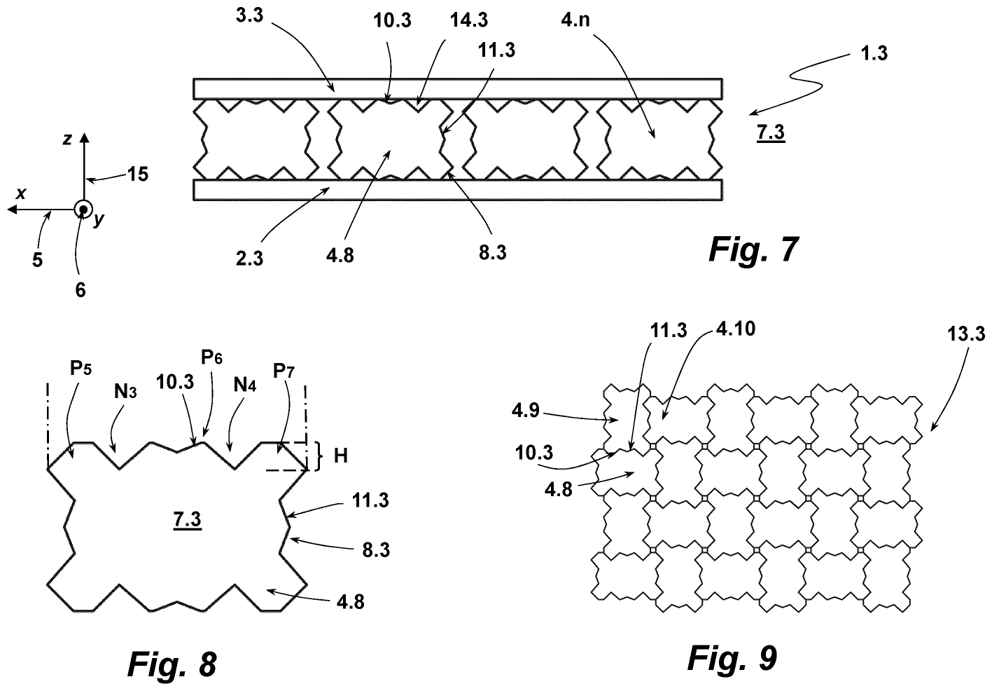

FIG. 7: a third exemplary embodiment of a mattress according to the invention in a lateral view,

FIG. 8: an enlarged view of a first intermediate element of the mattress from FIG. 7,

FIG. 9: the jigsaw-like arrangement of the intermediate elements of the mattress from FIG. 7 in a cutting pattern,

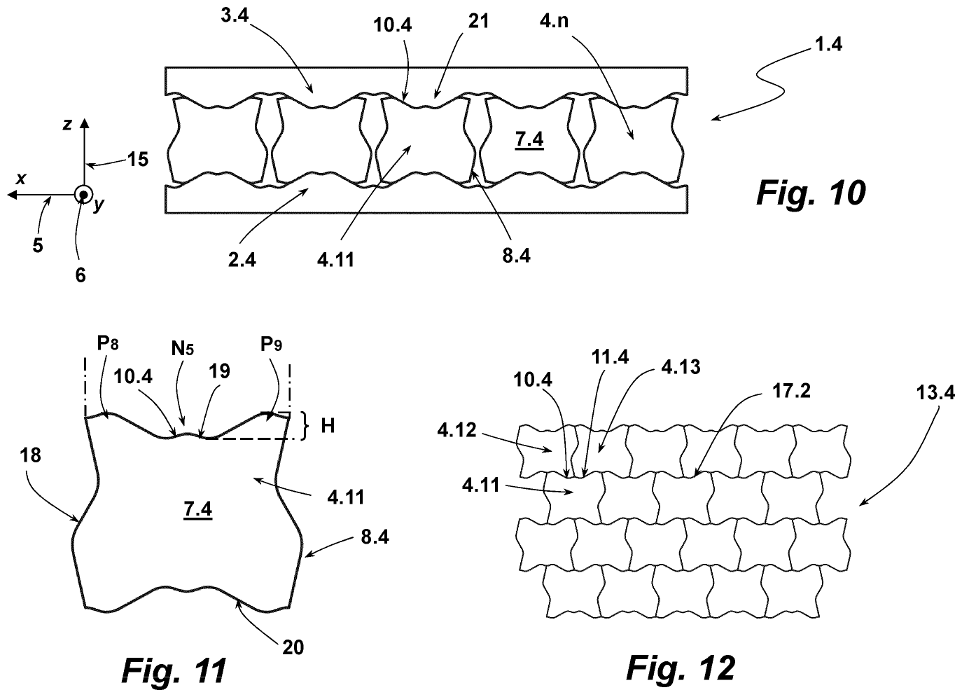

FIG. 10: a fourth exemplary embodiment of a mattress according to the invention in a lateral view,

FIG. 11: an enlarged view of a first intermediate element of the mattress from FIG. 10,

FIG. 12: the jigsaw-like arrangement of the intermediate elements of the mattress from FIG. 10 in a cutting pattern,

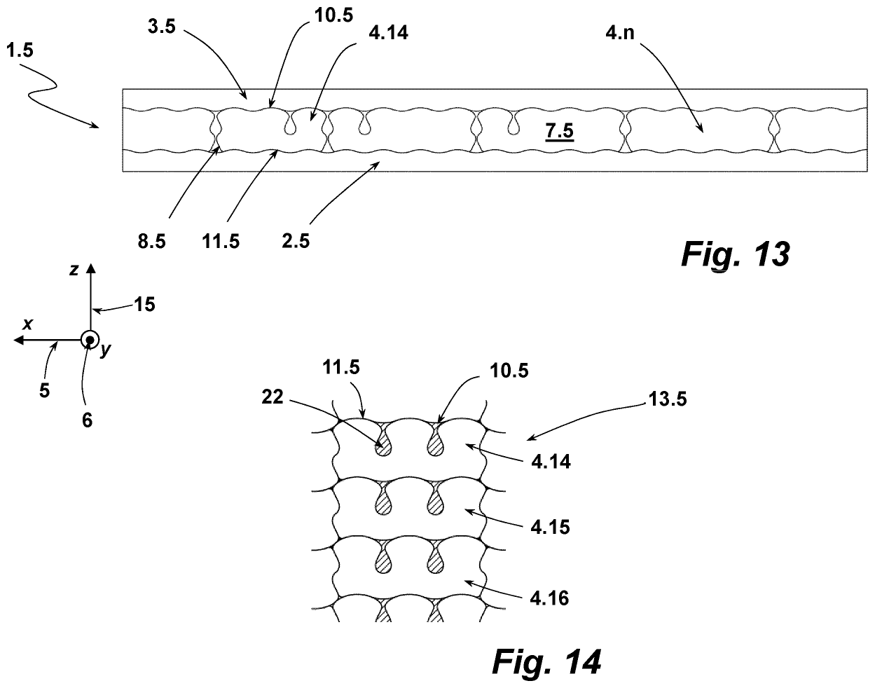

FIG. 13: a fifth exemplary embodiment of a mattress according to the invention in a lateral view, and

FIG. 14: the jigsaw-like interlocking of the first intermediate element of the mattress from FIG. 13.

FIG. 1 shows a first exemplary embodiment of an upholstered article embodied according to the invention as a mattress 1.1 in a schematically simplified view. A detail from a lateral view perpendicular to a profile axis 6, which extends transversely to the longitudinal axis of the mattress 5 (x-direction) and therefore in the y-direction, is shown. A multi-layered construction of the mattress 1.1 is shown with a lower layer 2.1 and an upper layer 3.1, in which both layers 2.1, 3.1 form two-dimensional cover layers, between which different types of intermediate elements 4.1, 4.2 with a longitudinal extension in the transverse direction 6 are arranged. The lower layer 2.1 and the upper layer 3.1 and the intermediate elements 4.1, 4.2 are foam elements which are each cut out from a block product. In the embodiment illustrated, a first intermediate element 4.1, of which the cross-sectional area 7.1 comprises a first peripheral outer contour 8.1, and a second intermediate element 4.2 with a second peripheral outer contour 9.1 are present.

The first outer contour 8.1 of the first intermediate element 4.1 comprises a first contour portion 10.1 facing towards the upper layer 3.1. The contour portion 10.1 has a nonlinear course in the form of an inverted hat profile with a profile depth H. To illustrate the extension of the first contour portion 10.1 in the x-direction, dot-dashed lines have been added in FIG. 2. With this embodiment, the intermediate element 4.1 comprises a correspondingly formed contour portion facing opposite to the first contour portion 10.1 and towards the lower layer 2.1. In this exemplary embodiment, this contour portion is embodied in mirror symmetry to the first contour portion 10.1. Accordingly, subsequent deliberations on the first contour portion 10.1 apply equally for the opposite mirror symmetrical contour portion.

The nonlinear course of the first contour portion (see FIG. 2) is formed by two positive structures P₁, P₂, between which one negative structure N₁ is arranged. In the region of the nadir of the negative structure N₁, a positive structure of smaller extension in the z-direction is disposed.

Accordingly, the contour of the negative structure N₁ is superimposed by the latter. The structures P₁, P₂, N₁ are inclined relative to a vertical (z-direction). Starting from the apex of the two positive structures P₁, P₂, the cross-sectional area of the intermediate element 4.1 in the x-y-plane increases successively over the height of the profile depth H of the contour portion 10.1 because of the inclined flanks of the positive structures P₁, P₂. Accordingly, during deflection, increasingly more cross-sectional area of the intermediate element 4.1 is brought into the deflection process. Contact between the intermediate element 4.1 and the upper layer 3.1 in the unloaded condition of the mattress 1.1 occurs exclusively at the apexes of the positive structures P₁, P₂. This explains the progressive deflection behaviour of the intermediate element 4.1 over the height of the profile depth H in the contour portion 10.1.

As a result of this contouring of the first contour portion 10.1 of the first intermediate element 4.1 and of the lower side of the upper layer 3.1 embodied in a planar manner, a cavity 14.1 is enclosed between the positive structures P₁, P₂ in the unloaded condition of the mattress 1.1. This cavity 14.1 presents a ventilation channel. The described cross-sectional geometry of the first contour portion 10.1 and the contact of the same with the upper layer 3.1 leads to a progressive deflection behaviour of the mattress 1.1. This progressive deflection behaviour continues until the profile height H is compressed. With this exemplary embodiment, the progressive deflection behaviour is limited to this initial deflection behaviour.

In addition to the functional adaptation of the first outer contour 8.1 regarding a progressively increasing compression strength through the construction of the first contour portion 10.1, the cross-sectional shapes of the first intermediate element 4.1 and of the second intermediate element 4.2 are matched to one another in such a manner that a counter-contour region 11.1 with a shape complementary to the first contour portion 10.1 is present on the second intermediate element 4.2. In the illustrated exemplary embodiment, the second intermediate element 4.2 is a quasi-double first intermediate element 4.1. The construction of the intermediate elements 4.1, 4.2 allows a waste-free cutting of the same from a block product—a foam block. FIG. 3 shows the cutting pattern 13.1 according to which the intermediate element 4.1 and further, identical intermediate elements, for example 4.3, 4.4 and 4.5, are shown, and the intermediate element 4.2 with further identical intermediate elements are fitted together in the manner of a jigsaw puzzle. The intermediate elements 4.1, . . . , 4.n can evidently be cut from one block in a waste-free cutting procedure.

In the subsequent exemplary embodiments, identical components are each marked with the same reference numbers, wherein only the numbering of the suffix is incremented correspondingly.

FIG. 4 shows a second exemplary embodiment of a mattress 1.2 according to the invention, once again illustrated with a detail from its lateral view. Intermediate elements 4.6 with a unified profile shape are shown in the illustrated cross-sectional area 7.2. As is evident from the enlarged view shown in FIG. 5 of the first intermediate element 4.6, its first contour portion 10.2 is visible as a part of the first peripheral outer contour 8.2 between the dot-dashed lines. With this exemplary embodiment also, the nonlinear course is formed by two positive structures P₃, P₄ at the edges and one negative structure N₂ disposed between them. The flanks of the structures P₃, P₄, N₂ are inclined relative to the vertical so that these intermediate elements 4.6 are also responsible for an initially progressive deflection behaviour.

The first contour portion 10.2 is shaped in such a manner that the latter simultaneously forms the counter-contour region 11.2 in a second intermediate element 4.7 or respectively 4.8. This is evident from the interlocking of several intermediate elements 4.6 in a cutting pattern 13.2 shown in FIG. 6, wherein further intermediate elements 4.7, 4.8 are placed in the manner of a jigsaw puzzle against the end face of the first intermediate element 4.6 and with a lateral offset (offset in x-direction). Moreover, in this exemplary embodiment, the complementarity requirement is fulfilled by a periodic continuation 17.1 of the first contour portion 10.2.

FIG. 7 shows a third exemplary embodiment of a mattress 1.3 with intermediate elements 4.8, in each case with identical geometries of their profile cross-sectional area. For the illustrated cross-sectional area 7.3, a first contour portion 10.3 with a nonlinear course structured by several positive structures P₅, P₆, P₇ each separated by one negative structure N₃, N₄ is disposed on the first outer contour 8.3. Because of the increasing cross-sectional area in the profile depth H of the first contour portion 10.3 in the event of a deflection of the mattress 1.3, an initially progressive deflection behaviour is also provided by this nonlinear course.

It is evident from the presentation of the intermediate element 4.8 in FIG. 8 that the first contour portion 10.3 is limited to the region between the dot-dashed marking lines on the upper side of the first outer contour 8.3. On the lateral face as a part of the peripheral first outer contour 8.3, a counter-contour region 11.3 is provided, the shape of which is embodied complementary to a portion of the first contour portion 10.3. Accordingly, an approximately gap-free jigsaw-like interlocking is possible with only minimal intermediate spaces, which, however, only lead to a low volume of waste with the cutting pattern 13.3 illustrated in FIG. 9 for cutting out the intermediate element and further identical intermediate elements 4.9, 4.10, . . . , 4.n. The intermediate spaces are obtained because of the construction of the first contour portion so that the two positive structures P₅, P₇ at the edges provide a flat face in the direction towards the upper layer 3.3. With reference to the extension of the first contour portion 10.3 in the x-direction of the mattress 1.3, these are very short and, in the illustrated exemplary embodiment, amount to less than 20% of the total extension of the intermediate element 4.8 in this direction.

FIG. 10 shows a fourth exemplary embodiment of a mattress 1.4 with intermediate elements 4.11. The cross-sectional geometry of the intermediate elements 4.11 disposed between the lower layer 2.4 and the upper layer 3.4 is identical. A first contour portion 10.4 with a nonlinear course, once again structured by two positive structures P₈, P₉ and one negative structure N₅ disposed between them, is disposed as a part or respectively portion of the first outer contour 8.4 of the intermediate element 4.11. The side of the upper layer 3, 4 facing towards the intermediate elements 4.11 is structured and in fact in a shape such that the upper layer comprises a transverse structuring, which is complementary to the negative structure N₅. Through this measure, a lateral securing 21 is embodied between the intermediate elements 4.11 and the upper layer 3.4. Accordingly, the intermediate elements 4.11 are fixed in position in the x-direction of the mattress 1.4. The side of the lower layer facing towards the intermediate elements 4.11 is embodied correspondingly. These intermediate elements 4.11 are connected to the lower layer 2.4 and the upper layer 3.4 only by the form-fit described. Regarding their structuring, the lower layer 2.4 and the upper layer 3.4 are construed in such a manner that the positive structures of the lower layer 2.4 engage in the negative structures of the upper layer 3.4. Accordingly, both layers—the lower layer 2.4 and the upper layer 3.4—can be cut out of one block without any cutting waste.

The enlarged view of the first intermediate element 4.11 in FIG. 11 shows its first contour portion 10.4 on the first outer contour 8.4 between the dot-dashed marking lines spaced in the y-direction. As shown in FIG. 12, the shape of the first contour portion 10.4 is construed in such a manner that a periodic continuation 17.2 forms a counter-contour region 11.4 (see FIG. 12). Moreover, second intermediate elements 4.12, 4.13, but identical to the first intermediate elements 4.11, adjoin the first contour portion 10.4 of a first intermediate element 4.11 in a form-fit manner in the cutting pattern 13.4. Accordingly, the intermediate elements 4.11, . . . , 4.n can be cut from one block product without any cutting waste.

Additionally, for the nonlinear lateral contour 18 of the first intermediate element 4.11, a form-fit positioning is provided by rotating the intermediate element disposed in each case adjacent in the cutting pattern 13.4 through 180°. To achieve both complementarity requirements, the upper side 19 facing towards the upper layer 3.4 and the lower side 20 of the first outer contour 8.4 facing towards the lower layer 2.4 are embodied in mirror-image symmetry to one another.

FIG. 13 shows a fifth exemplary embodiment of a mattress 1.5 according to the invention, wherein the intermediate layer is formed by differently shaped intermediate elements 4.14, . . . , 4.n. A first contour portion 10.5, in the nonlinear course of which the profile is adapted to the lower side of the upper layer 3.5 for the fixing of the loosely inserted intermediate elements 4.14, is disposed in the first outer contour 8.5 of the first intermediate element 4.14. The nonlinear course of the contour portion 10.5 is formed by a wavy-line shape.

For the jigsaw-like interlocking shown in FIG. 14 for a cutting pattern 13.5 without cutting loss, a complementary shaped counter-contour region 11.5 is provided on the lower side of the first intermediate element 4.14. Additionally, recesses with a narrow opening width (shown crosshatched in FIG. 14) are disposed on the upper side of the first outer contour 8.5 facing towards the upper layer 3.5. In this case, the first outer contour 8.5 deviates from the actual peripheral line of the cross section. The recesses allow an additional ventilation and also the adjustment of a reduced deflection firmness. These recesses 22 are not a part of the nonlinear course of the first contour portion 10.5.

### LIST OF REFERENCE NUMBERS

1.1, . . . , 1.5 mattress
2.1, . . . , 2.5 lower layer
3.1, . . . , 3.5 upper layer
4.1, . . . , 4.n intermediate element
5 longitudinal direction of the mattress
6 profile axis
7.1, . . . , 7.5 cross-sectional area
8.1, . . . , 8.5 first outer contour
9.1 second outer contour
10.1, . . . , 10.5 first contour portion
11.1, . . . , 11.5 counter-contour region
13.1, . . . , 13.5 cutting pattern
14, 14.2, 14.3 cavity
15 direction of the normal
17.1, 7.2 periodic continuation
18 lateral contour
19 upper side
20 lower side
21 lateral securing
22 recess
H profile depth
N₁, . . . , N₆ negative structure
P₁, . . . , P₉ positive structure

1-13. (canceled)

14. An upholstered article comprising:
a lower layer;
an upper layer; and
intermediate elements arranged between the lower layer and the upper layer, wherein:
the intermediate elements each comprise a profile axis transverse to a longitudinal direction of the upholstered article, in a cross-section perpendicular to the profile axis;
a first intermediate element comprises a first outer contour along a periphery of the first intermediate element; and
a second intermediate element comprises along a periphery of the second intermediate element either the first outer contour or a second outer contour different from the first outer contour;
the first outer contour comprises a first contour portion facing toward the upper layer or toward the lower layer with a nonlinear course; and
in the first outer contour and/or the second outer contour, at least one counter-contour region is present, the at least one counter-contour region having a course that is complementary at least in one part to the nonlinear course of the first contour portion.

15. The upholstered article according to claim 14, wherein the nonlinear course is provided by a series of positive structures and negative structures.

16. The upholstered article according to claim 15, wherein within the first contour portion two positive structures limit the first contour portion.

17. The upholstered article according to claim 14, wherein a surface of the upper layer facing toward the intermediate elements and/or a surface of the lower layer facing toward the intermediate elements comprises a three-dimensional structuring.

18. The upholstered article according to claim 17, wherein the intermediate elements contact the upper layer and/or the lower layer in a replaceable manner and without material bonding.

19. The upholstered article according to claim 17, wherein the three-dimensional structuring on the surface of the upper layer and/or on the surface of the lower layer is embodied such that the intermediate elements are fixed by the former in a form-fit manner in the transverse direction of the intermediate elements.

20. The upholstered article according to claim 19, wherein at least one portion of the three-dimensional structuring on the surface of the upper layer is complementary to an upper profile portion of the intermediate element, and/or at least one portion of the three-dimensional structuring on the surface of the lower level is complementary to a lower profile portion of the intermediate element.

21. The upholstered article according to claim 19, wherein the intermediate elements contact the upper layer, and/or the lower layer in a replaceable manner and without material bonding.

22. The upholstered article according to claim 19, wherein a first three-dimensional structuring is provided on the surface of the upper layer, and a second three-dimensional structuring is provided on the surface of the lower layer, and the first structuring is embodied complementary to the second structuring.

23. The upholstered article according to claim 14, wherein in the unloaded condition of the upholstered article a cavity is present between the upper portion of the intermediate elements and the upper layer and/or between the lower portion of at least some of the intermediate elements and the lower layer.

24. The upholstered article according to claim 23, wherein the intermediate element is embodied such that extension of the cavity in the transverse direction of the intermediate element decreases successively with an increasing loading on the mattress.

25. The upholstered article according to claim 14, wherein at least the first intermediate element and the second intermediate element are present and comprise a different firmness and/or a different profile contour and/or a different length in the direction of the profile axis.

26. The upholstered article according to claim 14, wherein the first intermediate element comprises inner recesses enclosed by the profile contour.

27. The upholstered article according to claim 14, wherein the upholstered article is a mattress.
